(19) United States
(12) Patent Application Publication
(10) Pub. No.: US 2026/0369928 A1
(43) Pub. Date: Nov. 19, 2026

(54) CONNECTOR

(71) Applicant: SUMITOMO WIRING SYSTEMS, LTD., Mie (JP)

(72) Inventor: Takeshi YAMAGUCHI, Mie (JP)

(21) Appl. No.: 19/138,666

(22) PCT Filed: Nov. 28, 2023
(86) PCT No.: PCT/JP2023/042445

§ 371 Date: Jun. 13, 2025

(30) Foreign Application Priority Data
Dec. 19, 2022 (JP) 2022-201767

(51) Int. Cl. H01R 13/627; H01R 13/52; H01R 13/633

(52) U.S. Cl. CPC H01R 13/6272; H01R 13/5202; H01R 13/633; H01R 2201/26

(57) ABSTRACT

A housing includes a housing body and a locking arm that is continuous with the housing body. The locking arm includes a locking hole in which a mating locking portion of a mating housing is provided. A holder includes a closure portion that closes a deflection space and an engaging portion that is provided beside the mating locking portion in the locking hole. The locking hole includes: a locking surface that faces the mating locking portion so as to be contactable to the mating locking portion in a direction in which the mating housing is disengaged from the housing body; and an engaging surface that is provided to face in a direction opposite to that in which the locking surface faces, and faces the engaging portion so as to be contactable to the engaging portion in a direction in which the holder is disengaged from the housing body.

### TECHNICAL FIELD

The present disclosure relates to a connector.

### BACKGROUND

Patent Document 1 discloses a connector that includes: a housing (a plug connector housing) that includes a locking arm (a latching arm); and a CPA that is attached so as to be movable between a locked position and an unlocked position relative to a mating housing (a cap connector housing). A cleaning element is attached to the CPA. Patent Document 1 discloses that the cleaning element removes waste accumulated on the back of the CPA as the CPA is moved to the unlocked position.

Patent Document 2 discloses a connector in which an attachment member is attached to a housing. The attachment member is configured to be movable relative to the housing between a retracted position at which the attachment member is retracted from a locking arm and a push position at which the locking arm is pushed from an unengaged position to an engaged position.

### PRIOR ART DOCUMENT

### Patent Document

Patent Document 1: JP 2006-505113 A
Patent Document 2: JP 2014-072011 A

### SUMMARY OF THE INVENTION

### Problems to be Solved

The connector disclosed in Patent Document 1 has a problem in that, if foreign matter such as mud solidifies in a deflection space where the locking arm is elastically deformed, the movement of the CPA is restricted, which prevents the cleaning element from exhibiting its function.

There is also another problem in that the mating housing is required to have a dedicated engagement structure configured to be engaged with only the CPA, which makes it difficult to apply the connector to an ordinary housing. The same is true for Patent Document 2. The connector disclosed in Patent Document 2 is also required to have a dedicated engagement structure configured to be engaged with only the attachment member, and there is a concern for a lack of versatility.

In view of the above, it is an object of the present disclosure to provide a connector that has enhanced versatility and in which an unlocking operation can be performed even in a situation where foreign matter adheres to the connector.

### Means to Solve the Problem

A connector according to the present disclosure includes: a housing that is mateable with a mating housing; and a holder that is attached to the housing. The housing includes a housing body and a locking arm that is continuous with the housing body. A deflection space is formed between the housing body and the locking arm, the deflection space being configured to allow an elastic displacement of the locking arm during a process of mating the housing with the mating housing. The locking arm includes a locking hole in which a mating locking portion of the mating housing is provided. The holder includes a closure portion that closes the deflection space and an engaging portion that is provided beside the mating locking portion in the locking hole. The locking hole includes: a locking surface that faces the mating locking portion so as to be contactable to the mating locking portion in a direction in which the mating housing is disengaged from the housing body; and an engaging surface that is provided to face in a direction opposite to that in which the locking surface faces, and faces the engaging portion so as to be contactable to the engaging portion in a direction in which the holder is disengaged from the housing body.

### Effect of the Invention

According to the present disclosure, it is possible to provide a connector that has enhanced versatility and in which an unlocking operation can be performed even in a situation where foreign matter adheres to the connector.

### BRIEF DESCRIPTION OF THE DRAWINGS

FIG. 1 is a cross-sectional view of a connector according to Embodiment 1 of the present disclosure in a state in which a holder is placed at a final engaging position and a housing is mated with a mating housing.

FIG. 2 is an enlarged cross-sectional view of a locking arm shown in FIG. 1 and a surrounding structure of the locking arm.

FIG. 3 is a cross-sectional view taken at a position different from that of FIG. 2 in the state in which the holder is placed at the final engaging position and the housing is mated with the mating housing.

FIG. 4 is a cross-sectional view when the holder has moved to a temporary engaging position from the state shown in FIG. 2.

FIG. 5 is a cross-sectional view when the holder has moved to the temporary engaging position from the state shown in FIG. 3.

FIG. 6 is a plan view of the connector in which the holder is placed at the final engaging position.

FIG. 7 is a back view of the connector in which the holder is placed at the final engaging position.

FIG. 8 is an enlarged cross-sectional view of an upper side of the connector in which the holder is placed at the final engaging position.

FIG. 9 is a back view of the housing.

FIG. 10 is a plan view of the housing.

FIG. 11 is a perspective view of the holder.

FIG. 12 is a plan view of the holder.

FIG. 13 is a side view of the holder.

FIG. 14 is a back view of the holder.

### DETAILED DESCRIPTION TO EXECUTE THE INVENTION

### Description of Embodiment of the Present Disclosure

First, aspects of an embodiment according to the present disclosure will be listed and described.

(1) A connector including: a housing that is mateable with a mating housing; and a holder that is attached to the housing, wherein the housing includes a housing body and a locking arm that is continuous with the housing body, a deflection space is formed between the housing body and the locking arm, the deflection space being configured to allow an elastic displacement of the locking arm during a process of mating the housing with the mating housing, the locking arm includes a locking hole in which a mating locking portion of the mating housing is provided, the holder includes a closure portion that closes the deflection space and an engaging portion that is provided beside the mating locking portion in the locking hole, and the locking hole includes: a locking surface that faces the mating locking portion so as to be contactable to the mating locking portion in a direction in which the mating housing is disengaged from the housing body; and an engaging surface that is provided to face in a direction opposite to that in which the locking surface faces, and faces the engaging portion so as to be contactable to the engaging portion in a direction in which the holder is disengaged from the housing body.

In the configuration described above, the closure portion of the holder closes the deflection space of the locking arm, and it is therefore possible to prevent foreign matter such as mud from entering the deflection space. When unmating the housing from the mating housing, by simply retracting the closure portion from the deflection space, the locked state of the locking arm can be released without any trouble. In particular, according to the configuration described above, the engaging portion of the holder faces the engaging surface of the locking hole so as to be contactable to the engaging surface of the locking hole, and thus the disengagement of the holder from the housing can be restricted. Accordingly, it is unnecessary to provide, in the housing, a dedicated engagement structure configured to be engaged with only the holder, and thus an existing housing can be used as it is.

(2) It is preferable that the housing body includes anti-reversal portions that are provided on opposite sides of the locking arm and protrude toward a space opposite to the deflection space, and the holder includes second engaging portions that face the anti-reversal portions so as to be contactable to the anti-reversal portions in the direction in which the holder is disengaged from the housing body.

According to the configuration described above, anti-reversal portions that are inherently included in a housing can be used as an engagement structure configured to be engaged with the holder.

(3) It is favorable that the locking arm includes an operating portion that can be displaced into the deflection space, and the holder includes a pressing portion that is provided so as to be movable relative to the housing between a final engaging position and a temporary engaging position and can press the operating portion into the deflection space when the holder is placed at the temporary engaging position, the final engaging position being a position at which the closure portion closes the deflection space, and the temporary engaging position being a position at which the closure portion retracts from the deflection space.

In the configuration described above, by pressing the pressing portion in the state in which the holder is placed at the temporary engaging position, the operating portion can be displaced into the deflection space, and the locked state of the locking arm can be released. Accordingly, it is unnecessary to completely remove the holder from the housing, and thus the operability of the unlocking operation can be improved.

(4) It is preferable that the housing body includes side walls that cover the locking arm from outside in a width direction that intersects with an elastic displacement direction of the locking arm, and the holder includes mating recess portions that are mated with the side walls.

In the configuration described above, the mating recess portions are mated with the side walls, and thus the holder is attached to the housing in a state in which the positional shift of the holder in the width direction is restricted. As the side walls, the side walls of an existing housing can be used as they are.

### Detailed Description of Embodiment of the Present Disclosure

A specific example of the present disclosure will be described below with reference to the drawings. It is to be noted that the present invention is not limited to the example given below, the scope of the present invention is indicated by the appended claims, and all changes that come within the meaning and range of equivalency of the claims are intended to be embraced within the scope of the present invention.

### Embodiment 1

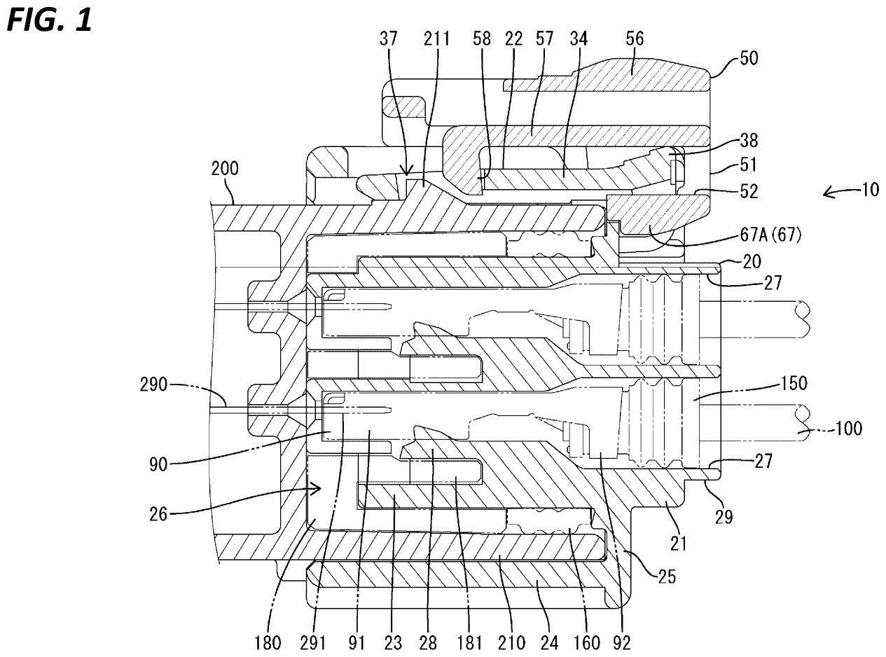

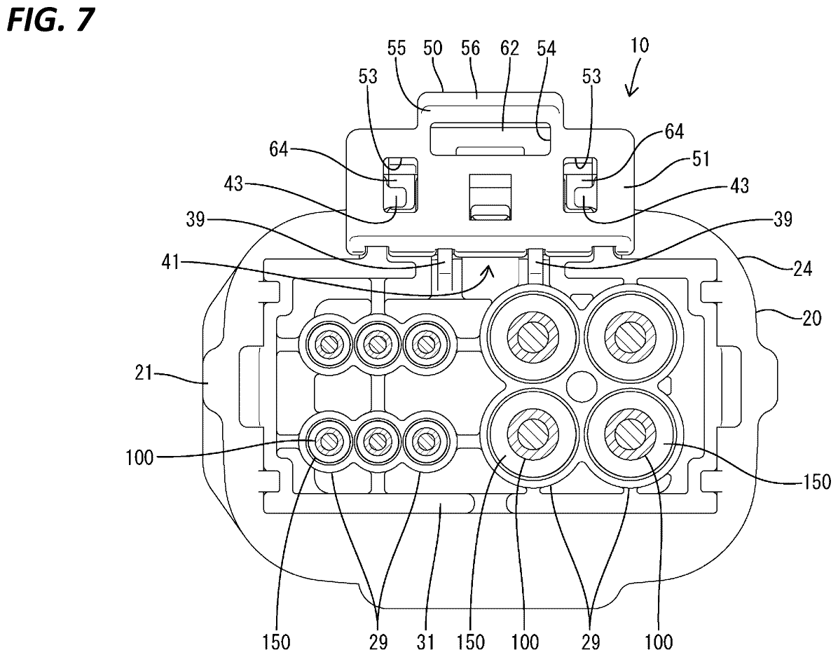

As shown in FIG. 1, a connector 10 according to Embodiment 1 of the present disclosure includes a housing 20, a holder 50 that is attached to the housing 20, and terminal fittings 90 that are housed in the housing 20. The housing 20 is mateable with a mating housing 200. In the description given below, when the term “forward-rearward direction” is used, a side on which a surface of the housing 20 and a surface of the mating housing 200 oppose each other when the housing 20 and the mating housing 200 are mated is defined as the forward side. The term “up-down direction” is based on the up-down direction in FIGS. 1 to 5. The term “right-left direction” is based on the right-left direction in FIGS. 7 to 9. The term “up-down direction” is synonymous with the term “height direction”, and the term “right-left direction” is synonymous with term “width direction”. The basis of these directions does not necessarily match that of when the connector 10 is mounted on a vehicle or the like.

### Mating Housing

The mating housing 200 is formed using a synthetic resin. As shown in FIG. 1, the mating housing 200 includes a prismatic hooded portion 210 that protrudes forward. In the hooded portion 210, tabs 291 of mating terminal fittings 290 are provided in a protruding manner. A mating locking portion 211 is provided in a protruding manner on an upper wall surface of the hooded portion 210.

### Housing and Terminal Fitting

The housing 20 is formed using a synthetic resin. As shown in FIG. 1, the housing 20 includes a housing body 21 and a locking arm 22 that is continuous with the housing body 21. The housing body 21 includes a terminal housing portion 23, a mating cylinder portion 24 that surrounds an outer circumference of the terminal housing portion 23, and a joining portion 25 that joins the terminal housing portion 23 and the mating cylinder portion 24. A space that is located at a position between the terminal housing portion 23 and the mating cylinder portion 24 and preceding to the joining portion 25 is defined as a mating space 26 in which the hooded portion 210 of the mating housing 200 can be fitted.

The terminal housing portion 23 includes a plurality of cavities 27. The cavities 27 are provided at positions corresponding to the tabs 291 of the mating terminal fittings 290. On an inner wall of each cavity 27, an elastically deformable lance 28 is formed in a protruding manner. The terminal fittings 90 are housed in the cavities 27, respectively, from the rearward side.

The terminal fittings 90 are formed using a conductive metal. As shown in FIG. 1, each terminal fitting 90 includes a cylindrical connecting portion 91 and a barrel portion 92 that is continuous with the rearward side of the connecting portion 91. When the housing 20 is mated with the mating housing 200, the tabs 291 of the mating terminal fittings 290 are inserted into the connecting portions 91, and the connecting portions 91 are electrically connected to the mating terminal fittings 290. Each barrel portion 92 is electrically crimp-connected to a terminal portion of an electric wire 100. Also, the barrel portion 92 is mechanically crimp-connected to a rubber stopper 150 that is attached to an outer circumference of the terminal portion of the electric wire 100. Each connecting portion 91 is engaged with the lance 28 of the corresponding cavity 27. The rubber stopper 150 is inserted into the cavity 27 together with the terminal fitting 90 and adheres to an inner circumferential surface of the cavity 27.

A sealing ring 160 is attached to an outer circumferential surface of the terminal housing portion 23. When the housing 20 is mated with the mating housing 200, the sealing ring 160 is sandwiched in a compressed state between the terminal housing portion 23 and the hooded portion 210, and thus a space between the housing 20 and the mating housing 200 is liquid-tightly sealed.

A front retainer 180 is attached to the terminal housing portion 23 from the forward side. The front retainer 180 is formed using a synthetic resin, and includes, as shown in FIG. 1, restricting pieces 181 that are provided at corresponding positions below the lances 28. The restricting pieces 181 restrict the deflection of the lances 28, and thus the terminal fittings 90 are secondarily prevented from falling apart from the inside of the cavities 27.

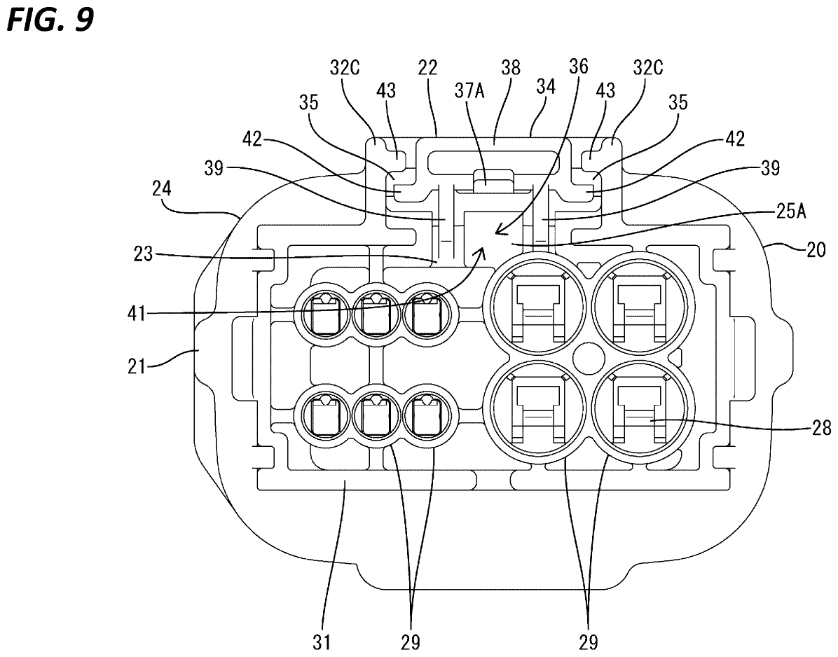

As shown in FIGS. 7 and 9, in a rear end portion of the terminal housing portion 23, a plurality of cavity tower portions 29 are formed in a protruding manner. Each cavity tower portion 29 has a cylindrical shape and includes, as shown in FIG. 7, a rear end portion of the cavity 27 into which the rubber stopper 150 is inserted. Also, in the rear end portion of the terminal housing portion 23, a rectangular frame 31 that surrounds an outer circumference of the cavity tower portions 29 is provided.

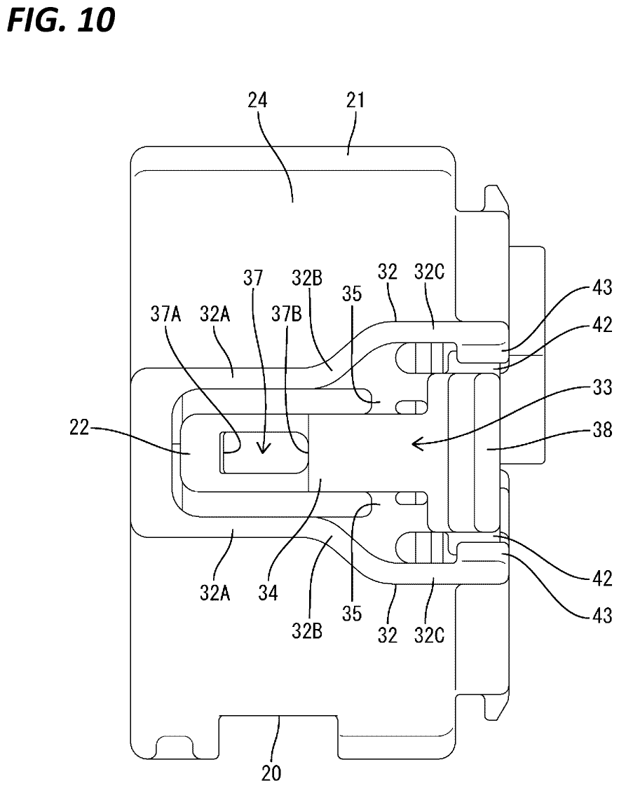

As shown in FIG. 10, a pair of side walls 32 that face each other in the width direction are provided upright on an upper wall of the mating cylinder portion 24, and an opening portion 33 that is open on the rearward side is formed between the side walls 32. The pair of side walls 32 include: a pair of side wall front portion 32A that are parallel to each other and extend in the forward-rearward direction; a pair of side walls rear portions 32C that are provided behind the side wall front portions 32A and extend in the forward-rearward direction at a spacing larger than that between the side wall front portions 32A; and a pair of side wall intermediate portions 32B that extend from the side wall front portions 32A to the side wall rear portions 32C in a widened manner.

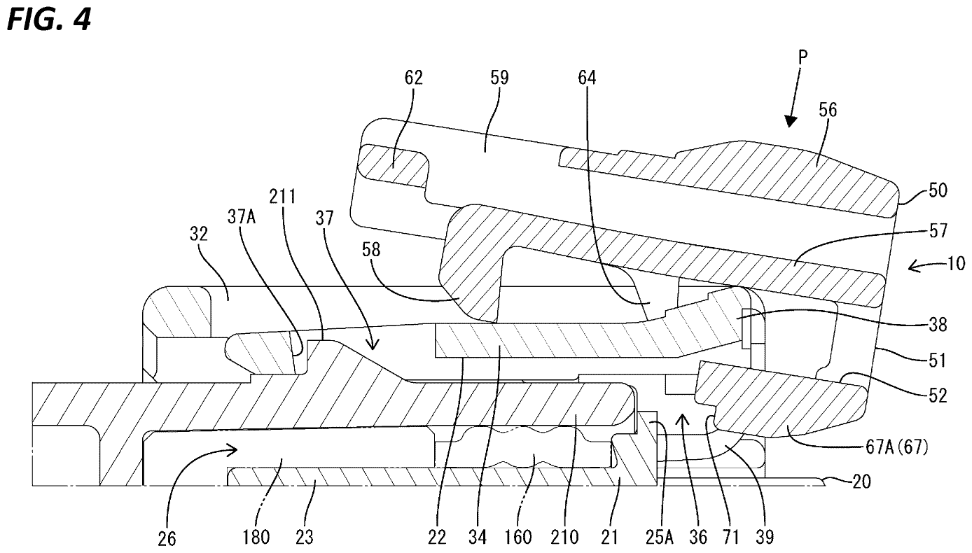

As shown in FIG. 10, the locking arm 22 is provided in the opening portion 33 of the mating cylinder portion 24 so as to be visible from above. The locking arm 22 includes: a strip-shaped arm body 34 that is provided above an upper surface of the terminal housing portion 23 and extends in the forward-rearward direction; and a pair of support portions 35 that extend from two opposing end surfaces of the arm body 34 in the width direction to the side wall intermediate portions 32B that face the support portions 35, respectively. The arm body 34 is configured to be elastically displaceable about the support portions 35 in the up-down direction like a see-saw. A deflection space 36 that allows the arm body 34 to be elastically displaced is provided between the housing body 21 and the arm body 34. As shown in FIGS. 4 and 9, a portion of the joining portion 25 forms a wall portion 25A that is located at a position that is spaced apart from the mating cylinder portion 24 and below the arm body 34. The deflection space 36 is provided above an upper end of the wall portion 25A on the rearward side. In the description given below, unless otherwise stated, a direction of the locking arm 22 is based on a state in which the arm body 34 naturally extends in the forward-rearward direction without being elastically displaced.

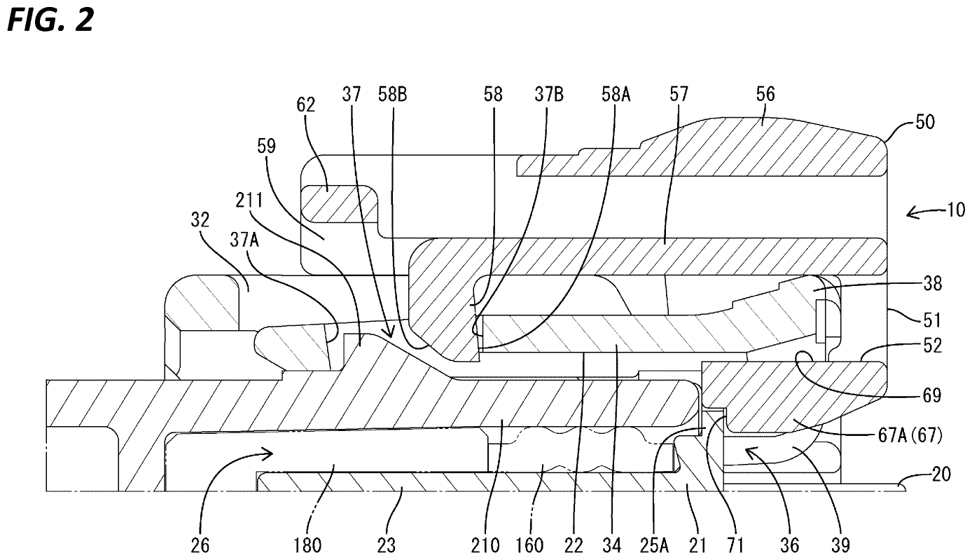

As shown in FIG. 2, the arm body 34 includes a locking hole 37 that extends through the arm body 34 in the up-down direction. The locking hole 37 has an opening that is elongated in the forward-rearward direction and in which the mating locking portion 211 of the mating housing 200 and an engaging portion 58, which will be described later, included in the holder 50 are provided side by side in the forward-rearward direction. A forward-side end surface (that faces toward the rearward side) of the locking hole 37 is defined as a locking surface 37A that is inclined forward relative to the up-down direction. The locking surface 37A is configured to be engageable with the mating locking portion 211. A rear-side end surface (that faces toward the forward side that is opposite to the side toward which the locking surface 37A faces) of the locking hole 37 is defined as an engaging surface 37B that is provided to extend along the up-down direction. The engaging surface 37B is configured to be engageable with the engaging portion 58 of the holder 50.

As shown in FIGS. 1 and 2, in a rear end portion of the arm body 34, an operating portion 38 that becomes gradually higher toward the rearward side is provided. As shown in FIG. 10, the operating portion 38 is shaped to be wider than the other portion of the arm body 34. The operating portion 38 is moved down toward the deflection space 36 during a process of mating the housing 20 with the mating housing 200.

As shown in FIGS. 4 and 9, in the rear end portion of the arm body 34, a pair of linking portions 39 are provided, the linking portions 39 extending downwardly forward in a curved manner from opposite sides of a lower surface of the operating portion 38 in the width direction, with their front ends being joined to a rear surface of the terminal housing portion 23. The linking portions 39 are elastically deformed during the process of mating the housing 20 with the mating housing 200. As shown in FIG. 9, a lower end side of each linking portion 39 is provided in a cutout space 41 formed by cutting out an upper wall portion of the frame 31.

As shown in FIGS. 9 and 10, in the rear end portion of the arm body 34, a pair of extension pieces 42 are provided, the extension pieces 42 extending outward in the width direction from lower end portions of two end surfaces of the operating portion 38 in the width direction. In the housing body 21, a pair of anti-reversal portions 43 are provided at positions that is above the extension pieces 42 and at which the anti-reversal portions 43 face the extension pieces 42. Each anti-reversal portion 43 has a plate shape that extends inward in the width direction from the corresponding side wall rear portion 32C, and, as shown in FIG. 9, is configured to be lower than an upper end of the side wall rear portion 32C and within the height of the operating portion 38. As shown in FIG. 10, a front end surface of each anti-reversal portion 43 is provided to extend along the width direction. If the operating portion 38 is turned upward, which is a direction that is not normally turned, during the mating process, the extension pieces 42 abut against lower surfaces of the corresponding anti-reversal portions 43, which restricts the operating portion 38 from being displaced further upward. Accordingly, it is possible to prevent the locking arm 22 from being turned beyond the elastic limit.

### Holder

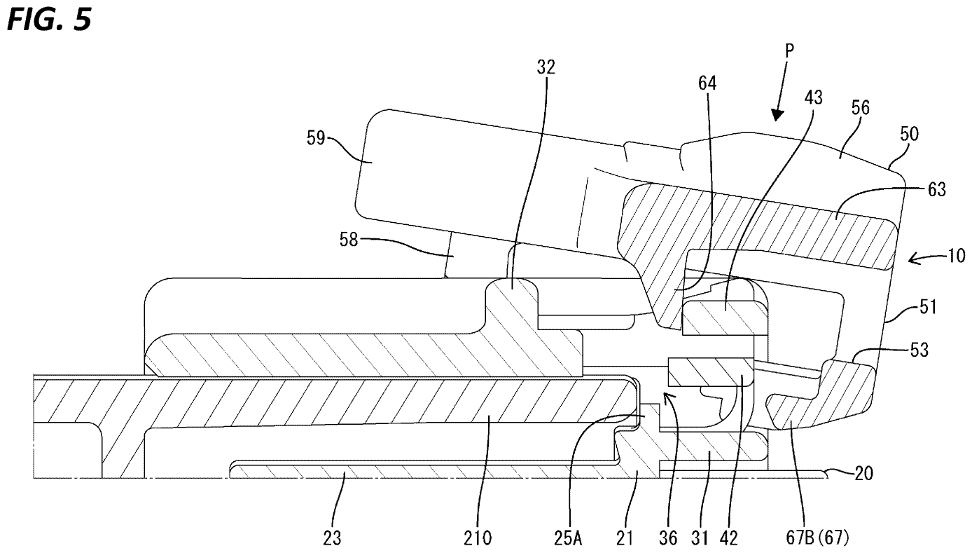

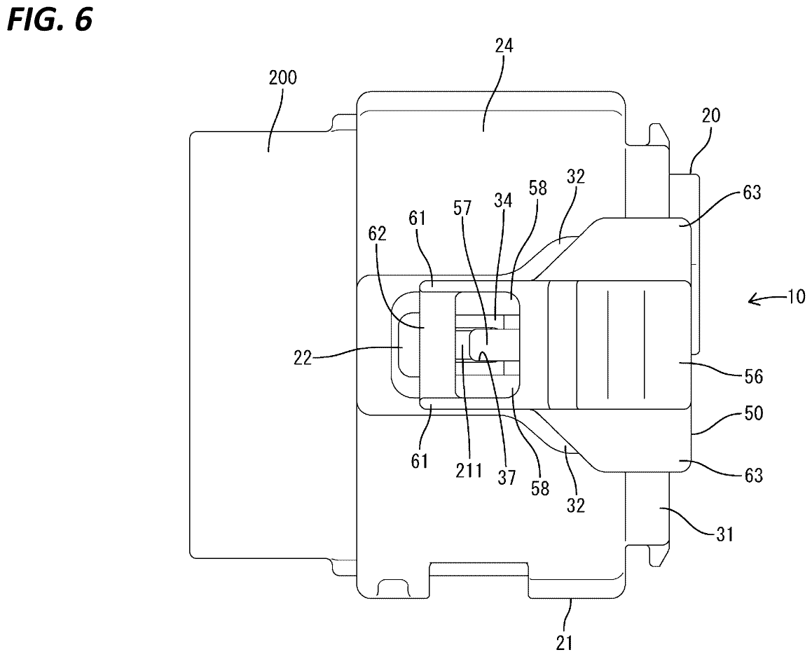

The holder 50 is formed using a synthetic resin and has a flat plate shape as a whole. As shown in FIG. 1, the holder 50 is provided on an upper end side of the connector 10 so as to cover an upper surface of the locking arm 22. The holder 50 is supported so as to be movable relative to the housing 20 between a final engaging position (see FIGS. 1 to 3 and FIGS. 6 to 8) and a temporary engaging position (see FIGS. 4 and 5) that is retracted from the final engaging position.

As shown in FIG. 14, the holder 50 includes a base portion 51 that has a rectangular outer shape as viewed from the back side. As shown in FIGS. 1 and 2, the base portion 51 is provided behind the operating portion 38. As shown in FIG. 14, in the base portion 51, a first through hole 52, second through holes 53, and a third through hole 54 that extend through the base portion 51 in the forward-rearward direction are formed. The first through hole 52 has a rectangular opening, and is formed at a center portion of the base portion 51 in the width direction as a result of a mold for molding the engaging portion 58 (not shown and described later) being pulled out. The second through holes 53 each have a rectangular opening, and are formed in opposite side portions of the base portion 51 in the width direction, respectively, as a result of a mold for molding second engaging portions 64 (not shown and described later) being pulled out. The third through hole 54 has an opening that is elongated in the width direction, and is formed at a position that is the center portion of the base portion 51 in the width direction and is above the first through hole 52 as a result of a mold for molding a spanning portion 62 (not shown and described later) being pulled out. At a center portion of the base portion 51 in the width direction on the upper end side, an arch portion 55 that defines an upper end of the third through hole 54 is formed.

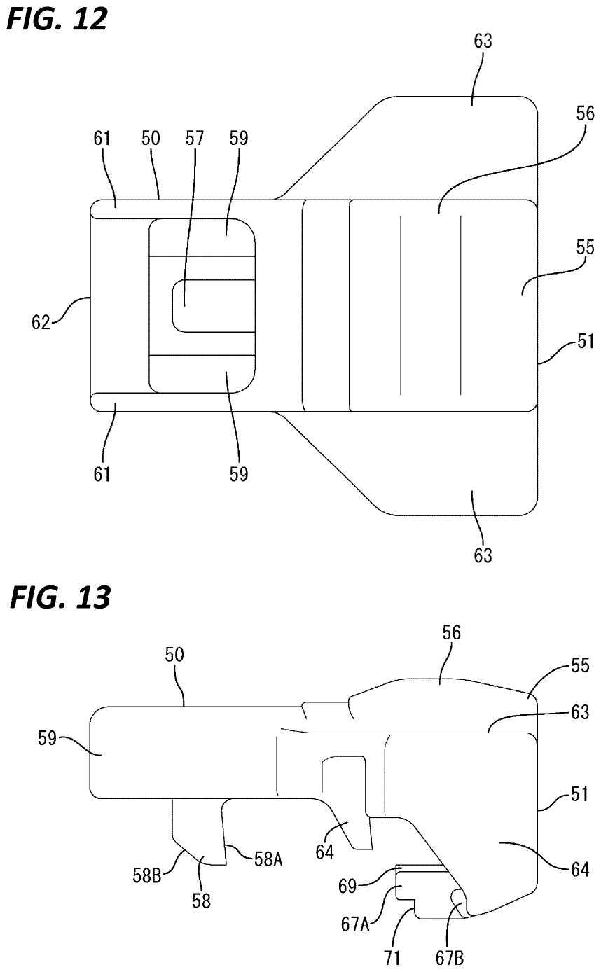

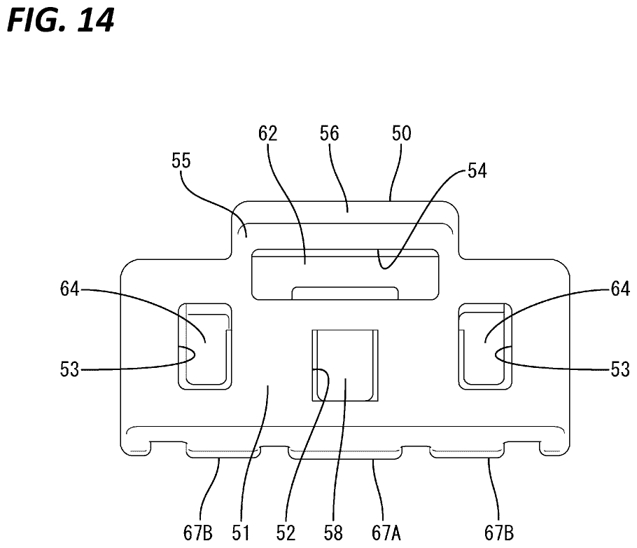

As shown in FIGS. 12 to 14, the holder 50 includes a pressing portion 56 that includes the arch portion 55 and extends forward from the arch portion 55. As shown in FIGS. 2 and 13, the pressing portion 56 has a plate shape with a mountain-like shape in a side view. The pressing portion 56 includes a stepped portion on an upper surface of the pressing portion 56 on the forward side and a curved top portion on the upper surface of the pressing portion 56 on the rear side. The top portion of the pressing portion 56 is provided at the highest position of the holder 50. When the holder is placed at the temporary engaging position, the pressing portion 56 is pressed from above and transmits the pressing force to the operating portion 38.

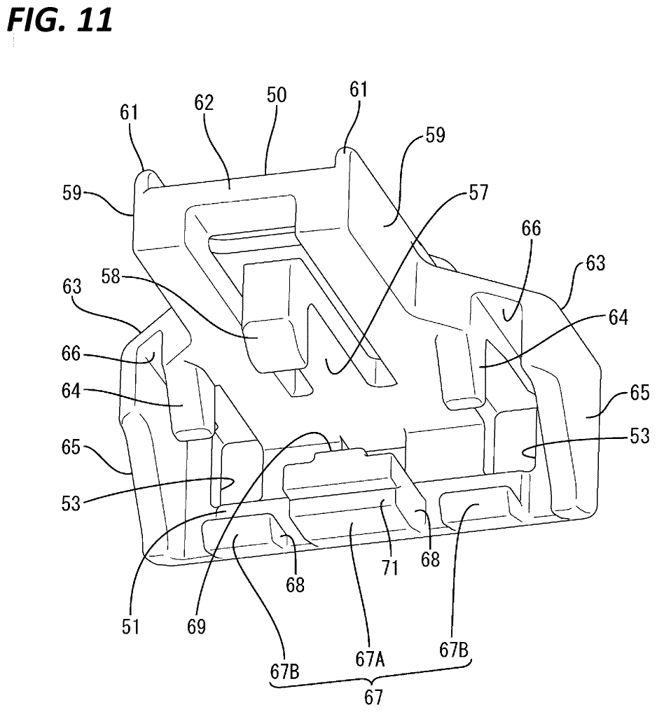

As shown in FIG. 11, the holder 50 includes an elastic arm portion 57 that extends forward from the center portion of the base portion 51 in the width direction. The elastic arm portion 57 has a rectangular cross-sectional shape, and is provided below the pressing portion 56. The elastic arm portion 57 is configured to be elastically displaceable about a connection portion that is connected to the base portion 51 in the up-down direction. In a front end portion of the elastic arm portion 57, the engaging portion 58 is formed in a downwardly protruding manner. The engaging portion 58 has a claw-like shape, and includes an engaged surface 58A that is inclined forward relative to the up-down direction in a rear surface of the engaging portion 58 as shown in FIG. 13. In a front surface of the engaging portion 58 on a lower end side thereof, an inclined surface 58B that is inclined rearward relative to the up-down direction is formed. As shown in FIG. 2, the engaged surface 58A of the engaging portion 58 is provided to face the engaging surface 37B of the locking hole 37. The inclined surface 58B of the engaging portion 58 is provided to face an inclined surface portion of the mating locking portion 211 and to be capable of avoiding interference with the mating locking portion 211 in a state in which the engaging portion 58 is placed in the locking hole 37. Accordingly, the mating locking portion 211 and the engaging portion 58 partially overlap in the forward-rearward direction in a state in which they are placed in the locking hole 37.

As shown in FIG. 11, the holder 50 includes a pair of protection arm portions 59 that are provided on opposite sides of the elastic arm portion 57 in the width direction. Each protection arm portion 59 has a rectangular cross-sectional shape and extends forward from a portion that is joined to the base portion 51. The protection arm portions 59 are provided in a height range that overlaps the elastic arm portion 57 in the up-down direction. On an upper surface of the protection arm portions 59, a pair of projections 61 that extend in the forward-rearward direction are formed. Upper ends of the projections 61 are provided above the elastic arm portion 57. As shown in FIG. 12, rear ends of the projections 61 are joined to the pressing portion 56. As shown in FIGS. 2 and 11, the holder 50 includes the spanning portion 62 that is provided to span between front end portions of the protection arm portions 59 at a position higher than the front end portions of the protection arm portions 59. The spanning portion 62 is provided above the elastic arm portion 57.

As shown in FIG. 11, the holder 50 includes a pair of extension portions 63 that extend forward from end portions of the base portion 51 on opposite sides in the width direction. As shown in FIG. 12, each extension portion 63 has a wing-like shape in a plan view, and is joined to a corresponding one of the protection arm portions 59 on the inner side in the width direction. The extension portions 63 and the protection arm portions 59 are rigid enough not to be elastically deformed. As shown in FIG. 11, in the extension portions 63, a pair of second engaging portions 64 are formed in a downwardly protruding manner at positions adjacent to the protection arm portions 59. The second engaging portions 64 each have a claw-like shape smaller than that of the engaging portion 58, and are provided behind the engaging portion 58 as shown in FIG. 13. As shown in FIG. 5, the second engaging portions 64 are configured to be engageable with the anti-reversal portions 43 when the holder is placed at the temporary engaging position.

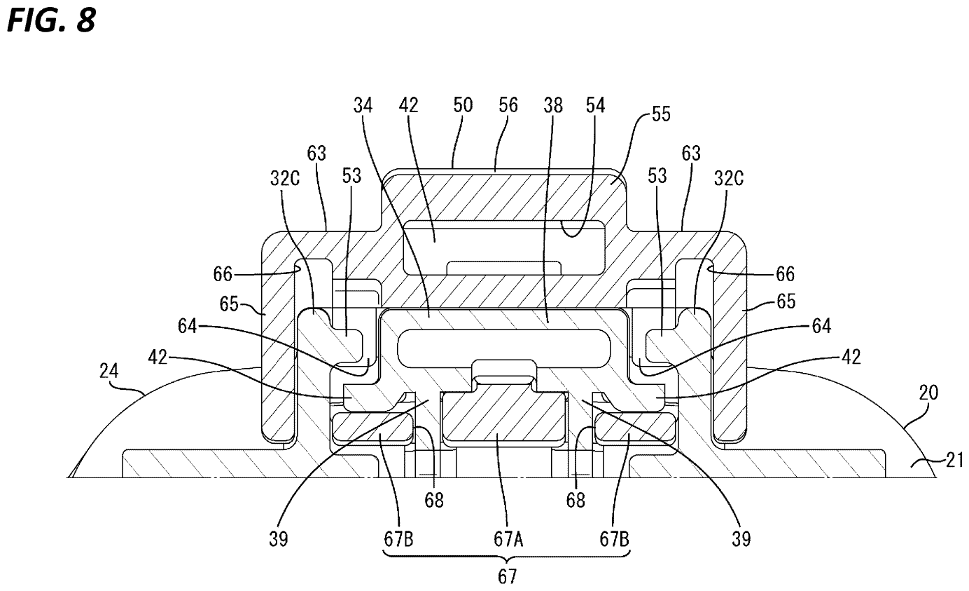

As shown in FIGS. 8 and 11, the extension portions 63 include a pair of side end portions 65 that protrude downward from an end portions of each extension portion 63 on opposite sides in the width direction. The side end portions 65 each have a plate shape that extends in the up-down direction and are provided along a side surface of a corresponding one of the side wall rear portions 32C as shown in FIG. 8. On lower surfaces of the extension portions 63, a pair of mating recess portions 66 are formed in a recessed shape. As shown in FIGS. 8 and 11, an inner side surface of each mating recess portion 66 (that faces inward in the width direction) is formed along an inner surface of a corresponding one of the side end portions 65. Another inner side surface of the mating recess portion 66 (that faces outward in the width direction) is formed along a side surface of a corresponding one of the second engaging portions 64.

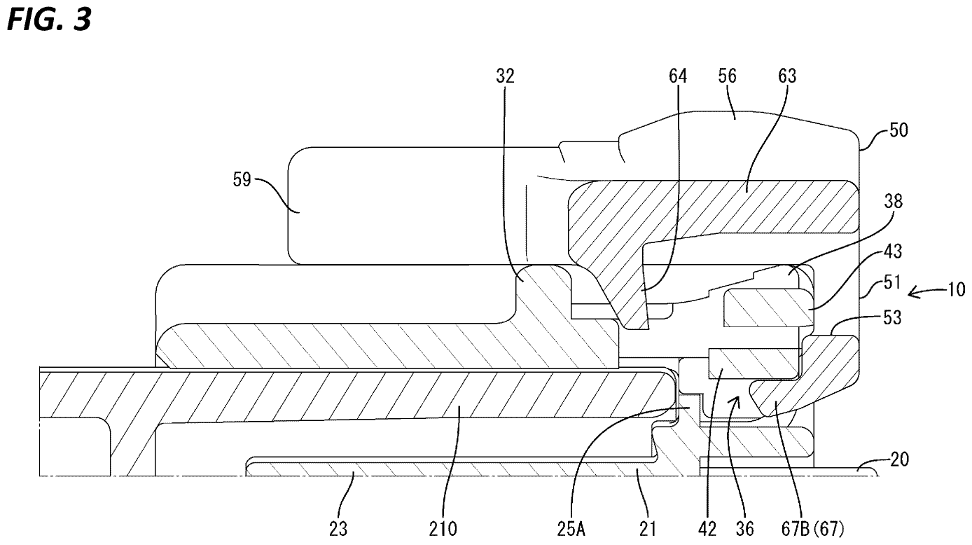

Also, the holder 50 includes a plurality of closure portions 67 that protrude forward from a lower end side of the base portion 51. The closure portions 67 each have a plate shape and are provided in the deflection space 36 as shown in FIGS. 2 and 3 so as to partially close the deflection space 36. In each closure portion 67, a surface that extends from a rear surface to a lower surface has a curved shape that is curved along the rotation trajectory of the holder 50 that rotates when the holder is moved from the final engaging position to the temporary engaging position. An upper surface of each closure portion 67 is flat in the forward-rearward direction.

In the case of Embodiment 1, as shown in FIG. 11, the closure portions 67 include a first closure portion 67A that protrudes forward from the center portion of the base portion 51 in the width direction and a pair of second closure portions 67B that protrude forward from opposite side portions of the base portion 51 in the width direction. A slit 68 is formed between the first closure portion 67A and each of the second closure portions 67B. As shown in FIG. 8, the linking portions 39 are placed in the slits 68, respectively. As shown in FIG. 2, the first closure portion 67A is provided below the first through hole 52. As shown in FIG. 3, the second closure portions 67B are provided below the second through holes 53, respectively.

As shown in FIG. 11, the first closure portion 67A is configured to be wider and thicker than the second closure portions 67B and elongated in the forward-rearward direction. As shown in FIGS. 11 and 13, on an upper surface of the first closure portion 67A, a rib 69 is formed to extend in the forward-rearward direction in a center portion of the first closure portion 67A in the width direction. An upper end surface of the rib 69 is a flat surface and faces a lower surface of the operating portion 38 so as to be contactable to the lower surface of the operating portion 38 (see FIG. 2). Also, in a front surface of the first closure portion 67A, a dent 71 is formed by cutting out corners of the lower end of the first closure portion 67A. The upper end of the wall portion 25A provided below the operating portion 38 is mated with the dent 71.

### Operational Function of Connector

In the mating space 26 of the housing 20, the hooded portion 210 of the mating housing 200 is inserted. After the locking arm 22 is elastically deformed, the mating locking portion 211 is fitted to an inner front portion of the locking hole 37, and the mating locking portion 211 faces the locking surface 37A of the locking hole 37 so as to be contactable to the locking surface 37A of the locking hole 37. This configuration restricts the mating housing 200 from being disengaged from the housing 20, and the mating state of the housing 20 and the mating housing 200 is maintained.

Next, the holder 50 is assembled to the housing 20 from the rearward side. Instead of this process, an operation of mating the housing 20 and the mating housing 200 may be performed in a state in which the holder 50 is supported relative to the housing 20 at the temporary engaging position that allows the locking arm 22 to be elastically deformed.

In the process of assembling the holder 50 to the housing 20, the holder 50 is inclined as a whole such that a front end portion of the holder 50 is raised, a lower end portion of the engaging portion 58 comes into contact with an upper surface of the arm body 34, lower end portions of the second engaging portions 64 come into contact with upper surfaces of the anti-reversal portions 43, and the closure portions 67 are provided so as to be capable of entering the deflection space 36 (see FIG. 4). At this time, the elastic arm portion 57 is deflection-deformed, and thus the lower end portion of the engaging portion 58 can slide on the upper surface of the arm body 34. Also, the side end portions 65 embrace the side wall rear portions 32C, which restricts the inclined holder 50 from being disengaged from the housing 20. When the process of assembling the holder 50 to the housing 20 is completed, the holder 50 is horizontally oriented as a whole, the engaging portion 58 is fitted to an inner rear portion of the locking hole 37, and the side wall rear portions 32C are fitted into the mating recess portion 66, respectively. The closure portions 67 are introduced into the deflection space 36. Accordingly, the holder 50 is supported relative to the housing 20 at the final engaging position.

When the holder 50 is placed at the final engaging position, as shown in FIG. 2, the engaged surface 58A of the engaging portion 58 faces the engaging surface 37B of the locking hole 37 so as to be contactable to the engaging surface 37B of the locking hole 37, which restricts the holder 50 from being disengaged from the housing 20 toward the rearward side. In particular, the engaging portion 58 is inclined in a direction in which it is engaged firmly with the engaging surface 37B of the locking hole 37, and thus the disengagement of the holder 50 is reliably restricted.

Also, when the holder 50 is placed at the final engaging position, a front surface of the base portion 51 faces a rear end surface of the arm body 34 and rear end surfaces of the side wall rear portions 32C so as to be contactable to the rear end surface of the arm body 34 and the rear end surfaces of the side wall rear portions 32C, which restricts the holder 50 from moving forward. The upper surface of the first closure portion 67A faces the lower surface of the operating portion 38 so as to be contactable to the lower surface of the operating portion 38 as shown in FIG. 2, and upper surfaces of the second closure portions 67B face lower surfaces of the extension pieces 42 so as to be contactable to the lower surfaces of the extension pieces 42 as shown in FIG. 3, which restricts the holder 50 from being displaced upward. As a result of displacement of the operating portion 38 into the deflection space 36 being restricted, the engagement state of the locking arm 22 and the mating locking portion 211 is maintained. Furthermore, as shown in FIG. 8, the side wall rear portions 32C are mated with the mating recess portions 66, and inner surfaces of the mating recess portions 66 face side surfaces of the side wall rear portions 32C so as to be contactable to the side surfaces of the side wall rear portions 32C, respectively, which restricts the holder 50 from being displaced in the width direction. As shown in FIG. 3, when the holder 50 is placed at final engaging position, the second engaging portions 64 are positioned ahead of the anti-reversal portions 43.

In the case of Embodiment 1, the elastic arm portion 57 is surrounded by the protection arm portions 59 and the spanning portion 62, and the projections 61 are formed on the protection arm portions 59. Accordingly, interference of foreign matter is unlikely to occur in the elastic arm portion 57, and it is therefore possible to prevent a situation in which the elastic arm portion 57 is accidentally elastically deformed to cause the engaging portion 58 to move apart from the locking hole 37.

A situation may occur where foreign matter such as mud adheres to the connector 10 mounted on a vehicle or the like. If the foreign matter enters the deflection space 36 of the locking arm 22 and solidifies, for example, the deflection of the locking arm 22 is restricted, and thus the locked state of the locking arm 22 may not be released. For this reason, Embodiment 1 is configured such that the base portion 51 closes the deflection space 36 from the rearward side, and the closure portions 67 fill the deflection space 36 as shown in FIGS. 2 and 3. Accordingly, it is possible to prevent foreign matter from entering the deflection space 36. Even if foreign matter enters the inside of the housing 20 via the first through hole 52 and the second through holes 53, the foreign matter that has entered the inside of the housing 20 just stays in an area on the wall portion 25A side where the deflection of the locking arm 22 is not hindered. Accordingly, as a result of the closure portions 67 being retracted from the deflection space 36, the locking arm 22 can be deflected.

As the closure portions 67 are retracted from the deflection space 36, the holder 50 is moved from the final engaging position to the temporary engaging position. At this time, the elastic arm portion 57 is raised, and the engaging portion 58 is moved onto the upper surface of the arm body 34 (see FIG. 4). In this state, when the holder 50 reaches the temporary engaging position, the second engaging portions 64 abuts against the front end surface of each anti-reversal portion 43 (see FIG. 5), which restricts the holder 50 from being moved further backward.

The closure portions 67 are inclined and retracted from the deflection space 36. As already described, foreign matter is not accumulated in the area of the deflection space 36 that is filled by the closure portions 67, and thus the operating portion 38 of the locking arm 22 is allowed to be displaced into the deflection space 36.

Next, an upper surface of the pressing portion 56 is pressed by a finger or the like (see an arrow P shown in FIG. 5). The operating portion 38 of the locking arm 22 is located under the pressing portion 56. For this reason, the pressing force applied to the pressing portion 56 is transmitted to the operating portion 38 via the holder 50. The operating portion 38 to which the pressing force is transmitted is pressed down into the deflection space 36, and the front end side of the locking arm 22 is raised, which causes the mating locking portion 211 to be apart from the locking hole 37. As a result, the locked state of the locking arm 22 with the mating locking portion 211 is released. By pulling the housing 20 away from the mating housing 200 in this state, the housing 20 and the mating housing 200 can be disengaged from each other.

As described above, according to Embodiment 1, when the holder 50 is held at the final engaging position relative to the housing 20, the closure portions 67 of the holder 50 close the deflection space 36 of the locking arm 22, and it is therefore possible to prevent foreign matter such as mud from entering the deflection space 36. On the other hand, at the time of disengaging the housing 20 and the mating housing 200 from each other, by moving the holder 50 to the temporary engaging position to cause the closure portions 67 to be retracted from the deflection space 36, the locked state of the locking arm 22 can be released.

In the case of Embodiment 1, the locking hole 37 that is inherently formed in the locking arm 22 of the housing 20 can be used as an engagement structure configured to be engaged with the engaging portion 58 of the holder 50. Accordingly, it is unnecessary to additionally provide a dedicated engagement structure configured to be engaged with only the holder 50. As a result, the scope of application of the housing 20 to which the holder 50 is to be attached can be expanded, and thus versatility can be improved. Also, as an engagement structure configured to be engaged with the second engaging portions 64 of the holder 50, the anti-reversal portions 43 that are inherently provided in the housing 20 can be used. Furthermore, as mating members for mating with the mating recess portions 66 that restrict the displacement of the housing 20 in the width direction, the side walls 32 of the housing 20 can also be used. Accordingly, according to Embodiment 1, as the housing 20 to which the holder 50 is to be attached, an existing housing 20 can be used as it is.

Also, according to Embodiment 1, by pressing the pressing portion 56 in the state in which the holder 50 is placed at the temporary engaging position, the operating portion 38 can be displaced into the deflection space 36, and the locked state of the locking arm 22 can be released. Accordingly, it is unnecessary to completely remove the holder 50 from the housing 20, and thus the operability of the unlocking operation can be improved.

### Other Embodiments of the Present Disclosure

Embodiment 1 disclosed herein is exemplary in all aspects, and thus should not be construed as limiting.

In the case of Embodiment 1 described above, the closure portion is configured to enter the inside of the deflection space to partially fill the deflection space of the locking arm. However, according to another embodiment, the closure portion may be configured as a rear portion of the base portion that simply closes the deflection space from the rearward side, without entering the inside of the deflection space.

In the case of Embodiment 1 described above, the closure portion is configured to include a plurality of closure portions including the first closure portion and the second closure portions that protrude from the front surface of the base portion. However, for example, in the case where the holder is attached to a housing without a linking portion, the closure portions do not need slits for the linking portion to escape, and thus the closure portion may be configured to include only one closure portion that protrudes from the front surface of the base portion.

In the case of Embodiment 1 described above, the support portions of the locking arm are configured to extend from the inner surfaces of the side walls to the arm body. However, according to another embodiment, the support portions of the locking arm may be provided upright from the upper surface of the terminal housing portion toward the arm body.

### LIST OF REFERENCE NUMERALS

10 Connector
20 Housing
21 Housing body
22 Locking arm
23 Terminal housing portion
24 Mating cylinder portion
25 Joining portion
25A Wall portion
26 Mating space
27 Cavity
28 Lance
29 Cavity tower portion
31 Frame
32 Side wall
32A Side wall front portion
32B Side wall intermediate portion
32C Side wall rear portion
33 Opening portion
34 Arm body
35 Support portion
36 Deflection space
37 Locking hole
37A Locking surface
37B Engaging surface
38 Operating portion
39 Linking portion
41 Cutout space
42 Extension piece
43 Anti-reversal portion
50 Holder
51 Base portion
52 First through hole
53 Second through hole
54 Third through hole
55 Arch portion
56 Pressing portion
57 Elastic arm portion
58 Engaging portion
58A Engaged surface
58B Inclined surface
59 Protection arm portion
61 Projection
62 Spanning portion
63 Extension portion
64 Second engaging portion
65 Side end portion
66 Mating recess portion
67 Closure portion
67A First closure portion
67B Second closure portion
68 Slit
69 Rib
71 Dent
90 Terminal fitting
91 Connecting portion
92 Barrel portion
100 Electric wire
150 Rubber stopper
160 Sealing ring
180 Front retainer
181 Restricting piece
200 Mating housing
210 Hooded portion
211 Mating locking portion
290 Mating terminal fitting
291 Tab

1. A connector comprising:
a housing that is mateable with a mating housing; and
a holder that is attached to the housing,
wherein the housing includes a housing body and a locking arm that is continuous with the housing body,
a deflection space is formed between the housing body and the locking arm, the deflection space being configured to allow an elastic displacement of the locking arm during a process of mating the housing with the mating housing,
the locking arm includes a locking hole in which a mating locking portion of the mating housing is provided,
the holder includes a closure portion that closes the deflection space and an engaging portion that is provided beside the mating locking portion in the locking hole, and
the locking hole includes: a locking surface that faces the mating locking portion so as to be contactable to the mating locking portion in a direction in which the mating housing is disengaged from the housing body; and an engaging surface that is provided to face in a direction opposite to that in which the locking surface faces, and faces the engaging portion so as to be contactable to the engaging portion in a direction in which the holder is disengaged from the housing body.

2. The connector according to claim 1,
wherein the housing body includes anti-reversal portions that are provided on opposite sides of the locking arm and protrude toward a space opposite to the deflection space, and the holder includes second engaging portions that face the anti-reversal portions so as to
be contactable to the anti-reversal portions in the direction in which the holder is disengaged from the housing body.

3. The connector according to claim 1,
wherein the locking arm includes an operating portion that can be displaced into the deflection space, and
the holder includes a pressing portion that is provided so as to be movable relative to the housing between a final engaging position and a temporary engaging position and can press the operating portion into the deflection space when the holder is placed at the temporary engaging position, the final engaging position being a position at which the closure portion closes the deflection space, and the temporary engaging position being a position at which the closure portion retracts from the deflection space.

4. The connector according to claim 1,
wherein the housing body includes side walls that cover the locking arm from outside in a width direction that intersects with an elastic displacement direction of the locking arm, and
the holder includes mating recess portions that are mated with the side walls.
